(19) United States
(12) Patent Application Publication
(10) Pub. No.: US 2023/0419717 A1
(43) Pub. Date: Dec. 28, 2023

(54) LEARNING METHOD, RE-IDENTIFICATION APPARATUS, AND RE-IDENTIFICATION METHOD

(71) Applicant: TOYOTA JIDOSHA KABUSHIKI KAISHA, Toyota-shi Aichi-ken (JP)

(72) Inventors: Norimasa Kobori, Nakano-ku Tokyo-to (JP); Rajat Saini, Edogawa-ku Tokyo-to (JP)

(73) Assignee: TOYOTA JIDOSHA KABUSHIKI KAISHA, Toyota-shi Aichi-ken (JP)

(21) Appl. No.: 18/201,329

(22) Filed: May 24, 2023

(30) Foreign Application Priority Data
Jun. 28, 2022 (JP) 2022-104057

(51) Int. Cl. G06V 40/10; G06V 10/77; G06V 10/74

(52) U.S. Cl. CPC G06V 40/10; G06V 10/7715; G06V 10/761

(57) ABSTRACT

A re-identification method for performing re-identification of a target object in image data using a machine learning model is proposed. The re-identification method comprises acquiring first image data and second image data in both of which the target object is, acquiring a plurality of first output data and a plurality of second output data by inputting the first image data and the second image data into the machine learning model, calculating a plurality of distances each of which is a distance in an embedding space between each of the plurality of first output data and each of the plurality of second output data, determining that the target object of the first image data and the target object of the second image data are similar when a predetermined number or more of the plurality of distances are less than a predetermined threshold.

### CROSS-REFERENCE TO RELATED APPLICATION

The present application claims priority under 35 U.S.C. § 119 to Japanese Patent Application No. 2022-104057, filed Jun. 28, 2022, the contents of which application are incorporated herein by reference in their entirety.

### BACKGROUND

### Technical Field

The present disclosure relates to a technique for re-identification of a target object in image data using a machine learning model. The present disclosure also relates to a technique of learning a machine learning model for the re-identification.

### Background Art

Patent Literature 1 discloses a method for re-identification of an object comprising: applying a convolutional neural network (CNN; Convolutional Neural Network) to a pair of images representing the object; and calculating a positive pair probability as to whether the pair of images represents the same object. Further, Patent Literature 1 discloses that the CNN comprises: a first convolutional layer; a first max pooling layer for obtaining a feature map of each of images; a cross-input neighborhood differences layer for producing neighborhood difference maps; a patch summary layer for producing patch summary feature maps; a first fully connected layer for producing a feature vector; a second fully connected layer for producing two scores representing positive pair and negative pair classes; and a softmax layer for producing positive pair and negative pair probabilities.

Patent Literature 2 discloses an object category identification method comprising: acquiring an object image to be identified; extracting edge mask information of the object image; cutting the object image depending on the edge max information; identifying a category of the object image depending on the cut object image and a predetermined object category identification model; and outputting an identification result.

### List of Related Art

Patent Literature 1: JP 2018/506788 A
Patent Literature 2: JP 2021/117969 A

### SUMMARY

In recent years, techniques for re-identification which identifies a target object in image data with the target object in another image data have been developed. The re-identification is helpful in tracking objects, in recognizing the surrounding environment, and the like.

A machine learning model is generally used for the re-identification technique. On the other hand, it is considered that each target object in a plurality of image data differs in viewpoint, illumination status, occurrence of occlusion, resolution, and the like. Therefore, the re-identification is one of the most difficult tasks in machine learning. In particular human re-identification, where the target object is a human, is a more difficult task, because the difference of clothing is anticipated and the frequency of occurrence of occlusion is high while higher accuracy is required.

As disclosed in Patent Literature 1 or Patent Literature 2, various techniques for the re-identification have been proposed with respect to a configuration of a machine learning model, a re-identification method using a machine learning model, and a learning method of a machine learning model. On the other hand, in machine learning, it is considered that an appropriate technique varies depending on a learning environment or a format of input data.

Therefore, regarding the re-identification, there is a demand for further proposals of techniques that can be expected to improve accuracy.

An object of the present disclosure is to provide a technique capable of improving accuracy regarding re-identification of a target object in image data.

A first disclosure is directed to a learning method of a machine learning model, the machine learning model comprising:
a plurality of feature extractor layers, each of which is sequentially connected and extracts a feature map of input; and
a plurality of embedding layers, each of which is connected to one of the plurality of feature extractor layers and converts the feature map to a feature vector on a embedding space with a predetermined dimension and outputs the feature vector.

The learning method according to the first disclosure comprises:
acquiring a plurality of training data with a label;
inputting the plurality of training data into the machine learning model;
acquiring a plurality of output data set, each of which is an output of one of the plurality of embedding layers;
calculating a loss function based on the plurality of output data set; and
learning the machine learning model such that the loss function decreases,
wherein the loss function includes a plurality of metric learning terms each of which is corresponding to one of the plurality of output data set, and
each of the plurality of metric learning terms is, for the corresponding output data set, configured to be:
a value is smaller as distances in the embedding space between outputs for training data with the same label among the plurality of training data are shorter; and
the value is smaller as distances in the embedding space between outputs for training data with the different label among the plurality of training data are longer.

A second disclosure is directed to a learning method further including the following features with respect to the learning method according to the first disclosure.

Each of the plurality of training data is image data in which a target object is, and
the label represents a class of the target object.

A third disclosure is directed to a learning method further including the following features with respect to the learning method according to the second disclosure.

The target object is a human, and
the class specifies an individual of the human.

A fourth disclosure is directed to a re-identification apparatus.

The re-identification apparatus according to the fourth disclosure comprises:
one or more processors; and
a memory storing executable instructions and a machine learning model, the machine learning model comprising:
   a plurality of feature extractor layers, each of which is sequentially connected and extracts a feature map of input; and
   a plurality of embedding layers, each of which is connected to one of the plurality of feature extractor layers and converts the feature map to a feature vector on a embedding space with a predetermined dimension and outputs the feature vector,
wherein the instructions, when executed by the one or more processors, cause the one or more processors to execute:
acquiring first image data and second image data in both of which a target object is;
acquiring a plurality of first output data, which is outputted from the plurality of embedding layers by inputting the first image data into the machine learning model;
acquiring a plurality of second output data, which is outputted from the plurality of embedding layers by inputting the second image data into the machine learning model; and
performing re-identification between the target object in the first image data and the target object in the second image data based on the plurality of first output data and the plurality of second output data, the performing re-identification including:
   calculating a plurality of distances, each of which is a distance in the embedding space between each of the plurality of first output data and each of the plurality of second output data; and
   determining that the target object of the first image data and the target object of the second image data are similar when a predetermined number or more of the plurality of distances are less than a predetermined threshold.

A fifth disclosure is directed to a re-identification apparatus further including the following features with respect to the re-identification apparatus according to the fourth disclosure.

The target object is a human.

A sixth disclosure is directed to a re-identification apparatus further including the following features with respect to the re-identification apparatus according to the fourth or the fifth disclosure.

The machine learning model has been learned by the learning method according to the first disclosure.

A seventh disclosure is directed to a re-identification method for performing re-identification of a target object in image data using a machine learning model, the machine learning model comprising:
a plurality of feature extractor layers, each of which is sequentially connected and extracts a feature map of input; and
a plurality of embedding layers, each of which is connected to one of the plurality of feature extractor layers and converts the feature map to a feature vector on a embedding space with a predetermined dimension and outputs the feature vector.

The re-identification method according to the seventh disclosure comprises:
acquiring first image data and second image data in both of which the target object is;
acquiring a plurality of first output data, which is outputted from the plurality of embedding layers by inputting the first image data into the machine learning model;
acquiring a plurality of second output data, which is outputted from the plurality of embedding layers by inputting the second image data into the machine learning model;
performing re-identification between the target object in the first image data and the target object in the second image data based on the plurality of first output data and the plurality of second output data, the performing re-identification including;
   calculating a plurality of distances, each of which is a distance in the embedding space between each of the plurality of first output data and each of the plurality of second output data; and determining that the target object of the first image data and the target object of the second image data are similar when a predetermined number or more of the plurality of distances are less than a predetermined threshold.
   An eighth disclosure is directed to a re-identification method further including the following features with respect to the re-identification method according to the seventh disclosure.

The target object is a human.

A ninth disclosure is directed to a re-identification method further including the following features with respect to the re-identification method according to the seventh or the eighth disclosure.

The machine learning model has been learned by the learning method according to the first disclosure.

A tenth disclosure is directed to a computer program for learning a machine learning model, the machine learning model comprising:
a plurality of feature extractor layers, each of which is sequentially connected and extracts a feature map of input; and
a plurality of embedding layers, each of which is connected to one of the plurality of feature extractor layers and converts the feature map to a feature vector on a embedding space with a predetermined dimension and outputs the feature vector.

The computer program according to the tenth disclosure, when executed by a computer, causes the computer to execute;
acquiring a plurality of training data with a label;
inputting the plurality of training data into the machine learning model;
acquiring a plurality of output data set, each of which is an output of one of the plurality of embedding layers;
calculating a loss function based on the plurality of output data set; and
learning the machine learning model such that the loss function decreases,
wherein the loss function includes a plurality of metric learning terms each of which is corresponding to one of the plurality of output data set, and
each of the plurality of metric learning terms is, for the corresponding output data set, configured to be:
a value is smaller as distances in the embedding space between outputs for training data with the same label among the plurality of training data are shorter; and
the value is smaller as distances in the embedding space between outputs for training data with the different label among the plurality of training data are longer.

An eleventh disclosure is directed to a computer program for performing re-identification of a target object in image data using a machine learning model, the machine learning model comprising:
a plurality of feature extractor layers, each of which is sequentially connected and extracts a feature map of input; and
a plurality of embedding layers, each of which is connected to one of the plurality of feature extractor layers and converts the feature map to a feature vector on a embedding space with a predetermined dimension and outputs the feature vector.

The computer program according to the eleventh disclosure, when executed by a computer, causes the computer to execute:
acquiring first image data and second image data in both of which the target object is;
acquiring a plurality of first output data, which is outputted from the plurality of embedding layers by inputting the first image data into the machine learning model;
acquiring a plurality of second output data, which is outputted from the plurality of embedding layers by inputting the second image data into the machine learning model;
performing re-identification between the target object in the first image data and the target object in the second image data based on the plurality of first output data and the plurality of second output data, the performing re-identification including;
calculating a plurality of distances, each of which is a distance in the embedding space between each of the plurality of first output data and each of the plurality of second output data; and
determining that the target object of the first image data and the target object of the second image data are similar when a predetermined number or more of the plurality of distances are less than a predetermined threshold.

According to the present disclosure, the output of the machine learning model is a plurality of the feature vectors outputted from the plurality of embedding layers. Then, identification of the target object in image data is performed by determining whether or not the predetermined number or more of the plurality of distances regarding the plurality of the feature vectors are less than the predetermined threshold. It is thus possible that the re-identification is performed by measuring similarity for a plurality of feature maps each of which has differing scale. Consequently, the accuracy of the re-identification can improve.

### BRIEF DESCRIPTION OF DRAWINGS

FIG. 1 is a conceptual diagram for explaining a human re-identification performed in human tracking;

FIG. 2 is a block diagram showing a configuration of a process according to human re-identification using a machine learning model;

FIG. 3 is a block diagram showing a schematic configuration of a machine learning model as a comparative of an embodiment of the present disclosure;

FIG. 4 is a block diagram showing a configuration example of a machine learning model according to an embodiment of the present disclosure;

FIG. 5 is a block diagram showing an example of the machine learning model according to an embodiment of the present disclosure;

FIG. 6 is a conceptual diagram showing an example of a plurality of feature vectors outputted by the machine learning model according to an embodiment of the present disclosure;

FIG. 7 is a conceptual diagram showing an example of the plurality of feature vectors outputted by the machine learning model according to an embodiment of the present disclosure when a plurality of image data is inputted;

FIG. 8 is a flowchart for explaining a learning method according to an embodiment of the present disclosure;

FIG. 9 is a conceptual diagram showing an example of a plurality of training data;

FIG. 10 is a conceptual diagram for explaining a plurality of metric learning terms;

FIG. 11 is a flowchart for explaining a re-identification method according to an embodiment of the present disclosure;

FIG. 12 is a conceptual diagram for explaining a plurality of distances calculated in the re-identification method according to an embodiment of the present disclosure; and

FIG. 13 is a block diagram showing a configuration of a re-identification apparatus according to an embodiment of the present disclosure.

### EMBODIMENTS

Hereinafter, embodiments of the present disclosure will be described with reference to the accompanying drawings. Note that when the numerals of numbers, quantities, amounts, ranges and the like of respective elements are mentioned in the embodiment shown as follows, the present disclosure is not limited to the mentioned numerals unless specially explicitly described otherwise, or unless the disclosure is explicitly specified by the numerals theoretically. Furthermore, configurations that are described in the embodiment shown as follows are not always indispensable to the disclosure unless specially explicitly shown otherwise, or unless the disclosure is explicitly specified by the structures or the steps theoretically. Note that in the respective drawings, the same or corresponding parts are assigned with the same reference signs, and redundant explanations of the parts are properly simplified or omitted.

### 1. Human Re-Identification

A re-identification method and a re-identification apparatus according to the present embodiment perform re-identification of a target object in image data using a machine learning model. In the following, it will be particularly described in a case applying to human re-identification in which the target object is a human.

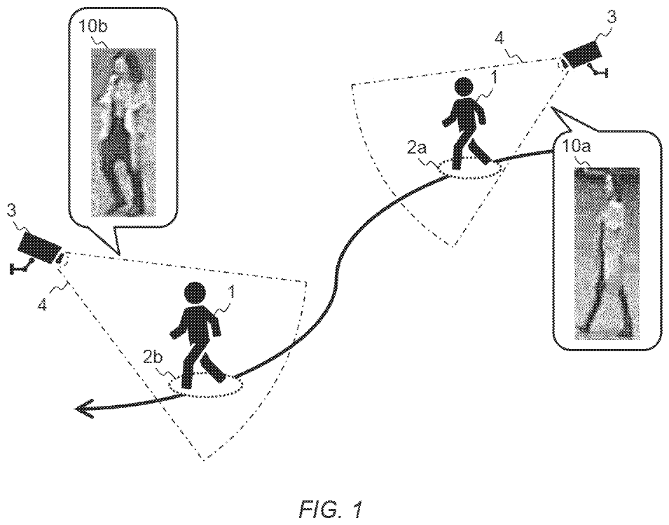

The human re-identification is useful, for example, in human tracking. FIG. 1 is a conceptual diagram for explaining the human re-identification performed in the human tracking of a human 1. FIG. 1 shows a case when the human 1 is moving along the arrow in the drawing. Here, at the two different points 2a and 2b on the moving path of the human 1, a camera 3 is placed respectively. That is, the human 1 is captured by the camera 3 at two different points 2a and 2b respectively. The camera 3 is, for example, a surveillance camera placed on a sidewalk.

In FIG. 1, the human tracking of the human 1 is performed using image data (in particular, a video as a set of image data) captured by the camera 3. However, an imaging range 4 of one camera is limited. Therefore, it has been conceivable to perform the human tracking of the human 1 over a plurality of the video each of which is captured by each camera 3. Thus, the range of the human tracking can be expanded. On the other hand, it is undesirable that each camera 3 is placed so that each imaging range 4 overlaps, because the costs get high. Also, for existing surveillance cameras, it is normal that the imaging range 4 is not overlapped.

If the imaging range 4 is not overlapped, the human tracking of the human 1 needs to be performed using spatially and temporally discontinuous image data. Therefore, the human re-identification is required. By the human re-identification, identification between a human in the image data captured by the one camera 3 and a human in the image data captured by another camera 3 is performed. It is thus possible that the human tracking of the human 1 performed on the image data captured by the one camera 3 can be continued even on the image data captured by another camera 3.

In FIG. 1, the image data 10a captured by the camera 3 placed at the point 2a and the image data 10b by the camera 3 placed at the point 2b are shown. And the same human 1 is in both the image data 10a and the image data 10b. Therefore, in the human re-identification, it is required to determine that a human in the image data 10a and a human in the image data 10b are the same human 1. If the human re-identification is properly performed, the human tracking of the human 1 can be continued from the point 2a to the point 2b.

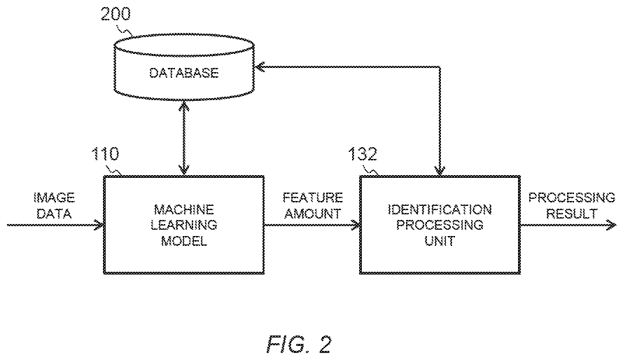

The human re-identification is generally performed using a machine learning model. FIG. 2 is a block diagram showing a schematic configuration of processes according to the human re-identification using a machine learning model 110.

The machine learning model 110 outputs a feature amount according to the image data of input. The machine learning model 110 may be realized as a part of a computer program and stored in a memory of a computer performing the human re-identification. Here, the human 1 is in the image data of input. In particular, the image data of input may be cropped image data such that the human 1 is conspicuously photographed (See the image data 10a and the image data 10b shown in FIG. 1). For example, by performing human detection for raw image data captured by the camera 3, the image data of input may be image data cropped such that the human 1 in the raw image data is conspicuously photographed. In this case, the human detection may employ a suitable known art.

The format of the feature amount that the machine learning model 110 outputs is determined based on the configuration, and it is a subject to consideration for the re-identification method. And the machine learning model 110 to be implemented has been learned. The learning method of the machine learning model 110 is also a subject to consideration.

A database 200 manages a plurality of image data. The database 200 may be realized by a database server configured to communicate with a computer performing the human re-identification. The database 200 is, for example, configured by successively acquiring image data captured by each camera 3. Each of the plurality of image data managed in the database 200 may be cropped image data such that the human 1 is conspicuously photographed as described above. In particular, in the database 200, information specifying an individual of the human 1 is associated with each of the plurality of image data. For example, ID information assigned to each individual is associated. Further, the feature amount of output of the machine learning model 110 may be associated with each of the plurality of the image data managed in the database 200. In this case, each of the plurality of image data may be input to the machine learning model 110 in advance to acquire the feature amount of that.

Typically, the human re-identification is performed by inputting the image data in which the human 1 to be re-identification is photographed and performing identification with the plurality of image data managed in the database 200. In this sense, the image data in which the human 1 to be re-identification is photographed may be referred to as a “query,” and the plurality of image data managed in the database 200 may be referred to as a “gallery”. Hereinafter, these terms are used as appropriate.

An identification processing unit 132 performs identification of the human 1 in image data based on the feature amount outputted from the machine learning model 110. In particular, the identification processing unit 132 performs identification between the human 1 in image data of the query and a human in image data of the gallery. In this way, the re-identification of the human 1 in image data of the query is realized. The identification processing unit 132 may be realized as a part of a program. The processing result of the identification processing unit 132 may be image data of the gallery that is determined to photograph the human 1 in image data of the query, or may be the information specifying the individual (e.g., ID information) that is determined to be the same as the human 1 in image data of the query. Alternatively, when identification is performed for between image data of the query and one of image data of the gallery, the processing result may be a result whether the human in image data is the same.

The identification processing unit 132 performs identification by measuring similarity with the feature amount of image data of the query (hereinafter, simply referred to as “the feature amount of the query”). In other words, identification is performed by comparing the feature amount of the query and the feature amount of the gallery. Then, it is determined that the human 1 in image data of the query is the same as a human in image data having the similar feature amount to the feature amount of the query. Here, the identification processing unit 132 may acquire the feature amount of the gallery as output of the machine learning model 110 or may acquire the feature amount of the gallery by referring to the database 200. In the former, the feature amount of the gallery is acquired by inputting the image data of the gallery into the machine learning model 110 as needed. In the latter, as described above, the feature amount may be associated with each of the plurality of image data managed in the database 200.

An index of the similarity and a method of determining similarity is determined based on the configuration of the identification processing unit 132, and it is a subject to consideration for the re-identification method.

As described above, the human re-identification using machine learning model 110 is performed. By the way, it is conceivable that image data of the query and the gallery are different each other in terms of the environment in which the image data are captured, the date and time at which the image data are captured, the camera 3 which captured the image data, and the like. Therefore, it is conceivable that a human in each image data has different viewpoints, illumination conditions, occlusion occurrence, resolution, clothing, and the like, even a pair of image data in which the same human is photographed. Thus, the human re-identification is one of the most difficult tasks in machine learning.

The re-identification method according to the present embodiment, in order to improve the accuracy of the human re-identification, has features in the configuration of the machine learning model 110 and the processes executed in the identification processing unit 132. And the learning method of the machine learning model 110 performing the re-identification method according to the present embodiment is also characteristic. Hereinafter, it will be described about the machine learning model 110 according to the present embodiment, the learning method of the machine learning model 110, and the re-identification method and the re-identification apparatus according to the present embodiment.

### 2. Machine Learning Model

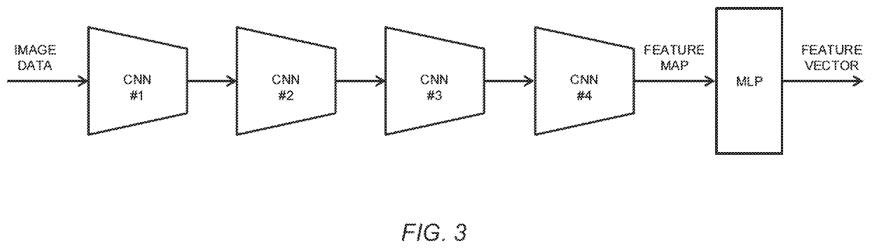

First, as compared with the present embodiment, it shows a schematic configuration of a typical machine learning model 110 in FIG. 3. The machine learning model 110 shown in FIG. 3 is composed of CNNs. In detail, in the machine learning model 110 shown in FIG. 3, four CNNs are sequentially connected, and a MLP (Multilayer Perceptron) is connected to the CNN of the final stage. Typically, the MLP is an affine layer.

As is well known, the CNN can extract an appropriate feature map for the image data. In particular, it is known that when a plurality of CNNs is sequentially connected, the extracted feature map represents more abstract features of the image data as the stage of the plurality of CNNs is later. This can also be called that each feature map by each of the plurality of CNNs has “different scale”. It is due to that each feature map by each of the plurality of CNNs generally has different data size. Furthermore, the plurality of feature maps having different scales are also referred to as “multi-scale” feature maps.

Input of the MLP shown in FIG. 3 is the feature map by the CNN of the final stage. The output of the MLP can be regarded as a vector (a feature vector) composed of the values of neurons in the output layer. That is, in the machine learning model 110 shown in FIG. 3, the feature amount outputted by the machine learning model 110 is the feature vector of the output of the MLP. Considering that the dimensions of the feature vector are determined based on the configuration of the MLP, the MLP can be regarded as a map that converts the feature map to the feature vector on an embedding space with a predetermined dimension.

Let's consider performing the human re-identification using the typical machine learning model 110 shown in FIG. 3. In this case, the machine learning model 110 is required to be learned such that a pair of feature vectors corresponding a pair of image data in which the same human is photographed is closer position on the embedding space each other. Furthermore, the machine learning model 110 is required to be learned such that a pair of feature vectors corresponding a pair of image data in which the different human is photographed is farther position on the embedding space each other. If the machine learning model 110 can be learned in this way, it can be expected that the human 1 in image data of the query is similar as a human in image data having the feature vector whose position is close to the feature vector of the query. That is, in the identification processing unit 132, the similarity is measured by the distance between the feature vectors on the embedding space.

It can be expected that performing the learning as described above for the typical machine learning model 110 shown in FIG. 3 is accomplished by a known learning method. However, even if sufficient learning with training data is performed by the known learning method, sufficient accuracy of the human re-identification cannot be achieved. This is thought to be because, as described above, the human in each image data has various different elements, even a pair of image data in which the same human is photographed. Therefore, even if increasing the number of the training data, overfitting for the training data is worried and it can not be expected to be sufficiently effective.

The inventors of the present disclosure have obtained an idea that, regarding the human re-identification, it is effective to perform identification by measuring the similarity for the plurality of feature maps having different scales. This is because, for determining robustly for various elements whether or not it is the same as the human 1 in image data of the query, it is considered to be effective to judge comprehensively about various features. That is, because each of the plurality of feature maps having different scales represents different features from each other, each feature is expected to be useful to discriminate between two individuals.

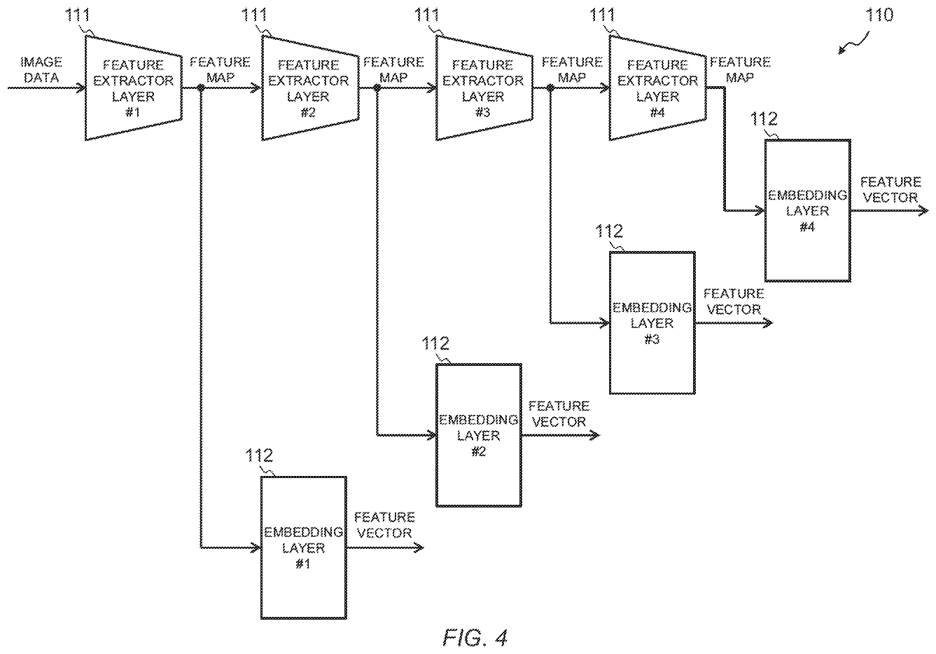

The machine learning model 110 according to the present embodiment is configured based on the above idea. Hereinafter, it will be described about the machine learning model 110 according to the present embodiment. FIG. 4 is a block diagram showing a configuration example of the machine learning model 110 according to the present embodiment.

The machine learning model 110 according to the present embodiment comprises a plurality of feature extractor layers 111 each of which is sequentially connected, and a plurality of embedding layers 112 each of which is connected to one of the plurality of feature extractor layers 111. In the example shown in FIG. 4, the machine learning model 110 comprises four feature extractor layers (#1, #2, #3, #4), and four embedding layers 112 (#1, #2, #3, #4) connected to each of the plurality of the feature extractor layers. However, the number of the plurality of feature extractor layers 111 and the plurality of embedding layers 112 may be suitably modified depending on the environment to which the present embodiment is applied. The plurality of embedding layers 112 may also be configured to connect to a portion of the plurality of feature extractor layers 111. For example, in FIG. 4, the machine learning model 110 may not comprise the embedding layer of #1 and #3. In this case, the number of the plurality of feature extractor layers 111 is 4, and the number of the plurality of the embedding layers 112 is 2.

Each of the plurality of feature extractor layers 111 is configured to extract the feature map of input. Here, the input of the first stage of the plurality of feature extractor layers 111 is image data, and the input of the other stages of the plurality of feature extractor layers 111 is the feature map outputted by the front stage extractor layer among the plurality of the feature extractor layers 111. Therefore, the plurality of feature extractor layers 111 outputs the plurality of feature maps having different scales. And generally, each of the plurality of feature maps has different data size each other.

Each of the feature extractor layers 111 can be realized by CNN as one example. As another example, each of the feature extractor layers 111 can be realized by patch layer and encoder layer based on the transformer architecture, especially the ViT (Vision Transformer). In this case, the patch layer divides the input into a plurality of patches, and the encoder layer outputs the feature map with a plurality of patches as input.

The input of each of the plurality of embedding layers 112 is the feature map outputted by one of the plurality of feature extractor layers 111 to be connected. Then, each of the plurality of embedding layers 112 converts the feature map to a feature vector on an embedding space with a predetermined dimension, and outputs the feature vector. Especially, the plurality of embedding layers 112 is configured such that the dimensions of the feature vectors outputted from the respective embedding layers are equal to each other. That is, the feature vectors outputted from the plurality of embedding layers 112 are vectors on the same embedding space.

Each of the embedding layers 112 can be realized by MLP as one example. Typically, the MLP may be an affine layer. In this instance, in order to make the dimensions of the feature vectors outputted are equal to each other, the number of neurons in the output layers of each of the MLPs should be equal.

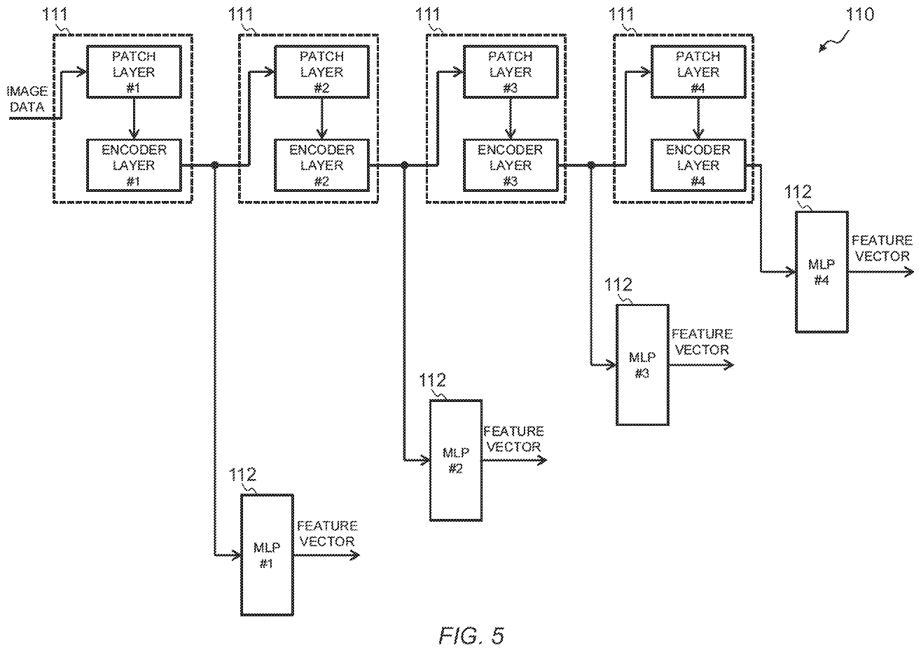

FIG. 5 shows an example of the machine learning model 110 according to the present embodiment in which each feature extractor layer 111 is realized by the patch layer and the encoder layer, and each embedding layer 112 is realized by the MLP.

As described above, according to the machine learning model 110 according to the present embodiment, it is possible to acquire a plurality of feature vectors each of which is on the same embedding space respectively for the plurality of feature maps having different scales. That is, the feature amount outputted by the machine learning model 110 according to the present embodiment is the plurality of feature vectors outputted by the plurality of embedding layers 112. Incidentally, each of the plurality of feature extractor layers 111 may have a different structure and independent parameters respectively. For example, each of the plurality of feature extractor layers 111 may have different layer depths from each other. Furthermore, each of the plurality of embedding layers 112 may also have a different structure and independent parameters respectively.

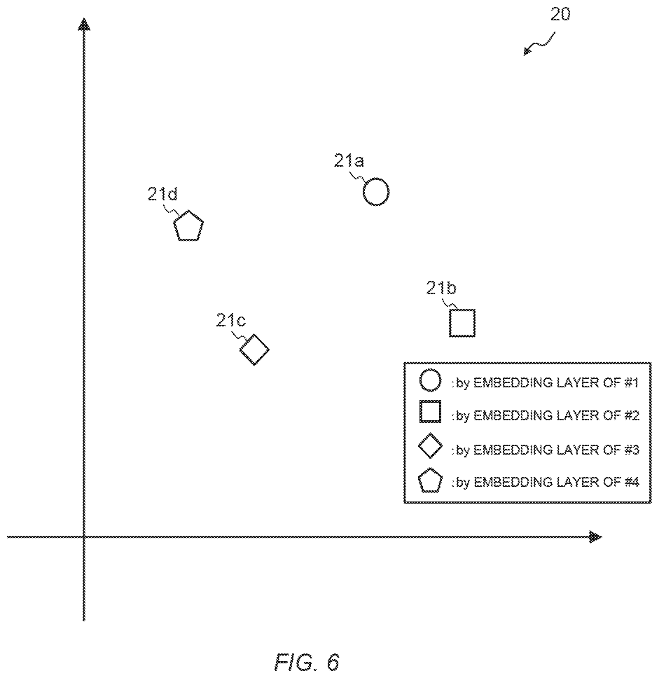

FIG. 6 shows an example of the plurality of feature vectors outputted when image data is input into the machine learning model 110 shown in FIG. 4. In the example shown in FIG. 6, the positions on the embedding space 20 of the four feature vectors 21a, 21b, 21c, and 21d outputted by the four embedding layers (#1, #2, #3, #4) are shown in a particular shape. Here, the dimension of the embedding space 20 is two-dimensional for the sake of simplicity.

### 3. Learning Method

Hereinafter, it will be described about the learning method according to the present embodiment.

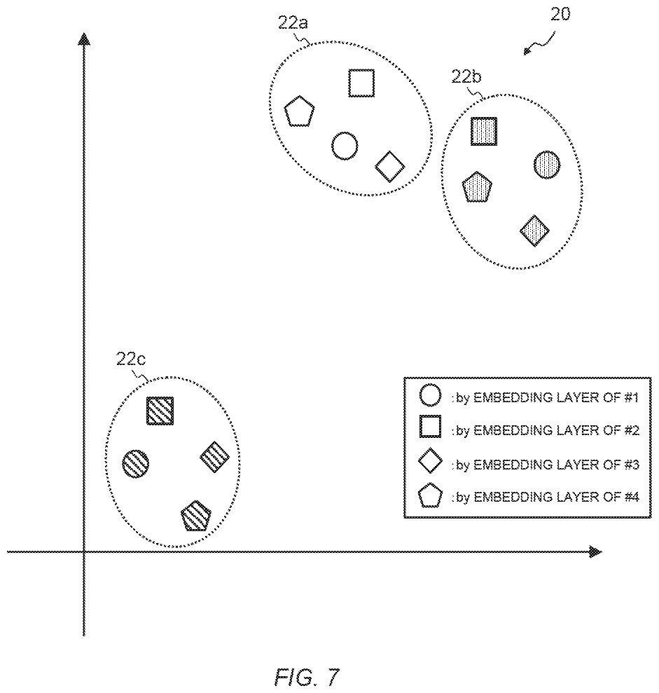

FIG. 7 shows an example of the plurality of feature vectors outputted by the machine learning model 110 shown in FIG. 4, when inputting three image data where two of these which photograph the same human and one of these which photographs the different human from the other two image data. FIG. 7 is a similar drawing to FIG. 6. In the example shown in FIG. 7, the plurality of feature vectors 22a and 22b are output when inputting two image data which photograph the same human. On the other hand, the plurality of feature vectors 22c is output when inputting the image data which photographs the different human from the other two image data.

As shown in FIG. 7, when performing the human re-identification using the machine learning model 110 according to the present embodiment, the machine learning model 110 is required to be learned such that pairs of feature vectors for image data in which the same human 1 is photographed are closer position on the embedding space. Furthermore, the machine learning model 110 is required to be learned such that pairs of feature vectors for image data in which the different human is photographed are farther position on the embedding space. If the machine learning model 110 has been learned as shown in FIG. 7, identification can be performed considering each of the plurality of feature maps having different scales by the re-identification method according to the present embodiment. The re-identification method according to the present embodiment will be described later.

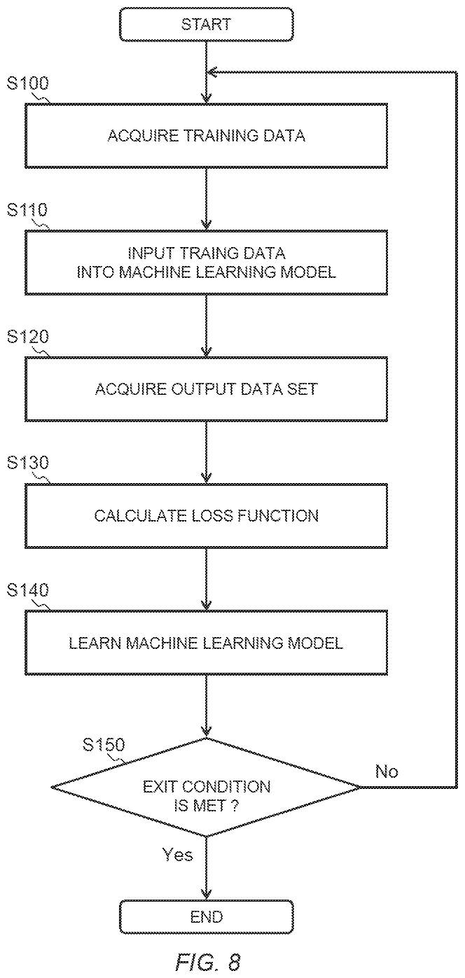

The learning method according to the present embodiment accomplishes that the machine learning model 110 is learned as shown in FIG. 7. FIG. 8 is a flow chart for explaining the learning method according to the present embodiment. Each process of the flowchart shown in FIG. 8 is executed at every predetermined processing period.

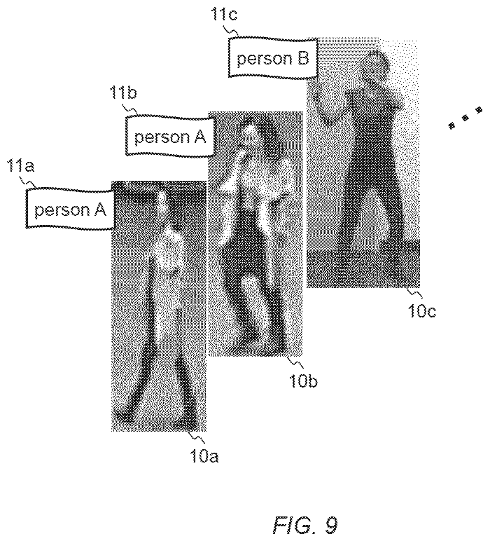

In Step S100, a plurality of training data for learning the machine learning model 110 is acquired. Each of the plurality of training data is being with a label. FIG. 9 shows an example of the plurality of training data. In FIG. 9, three image data 10a, 10b, and 10c in each of which a human is photographed are particularly shown as the plurality of training data. And the three image data 10a, 10b, and 10c are being with the label 11a, 11b, and 11c respectively. The label is information specifying the human in image data. That is, in FIG. 9, it shows that the same human is photographed in the image data 10a and 10b.

See FIG. 8 again. After Step S100, the processing proceeds to Step S110.

In Step S110, the plurality of training data acquired in Step S100 is inputted into the machine learning model 110.

After Step S110, the processing proceeds to Step S120.

In Step S120, output of the machine learning model 110 for the input in Step S120 is acquired. In particular, a plurality of output data set which is output of the plurality of embedding layers 112 is acquired. Each of the plurality of output data set is an output of one of the plurality of embedding layers 112 for the input. That is, each of the plurality of output data set is a set of the feature vector for the feature map having a specific scale. For example, when the machine learning model 110 is configured as shown in FIG. 4, one of the plurality of output data set is a set of output of the embedding layer of #1 for the input. And, four output data sets for each of the embedding layer of #1, #2, #3, and #4 are acquired.

After Step S120, the processing proceeds to Step S130.

In Step S130, a loss function is calculated based on the plurality of output data set acquired in Step S120. In the learning method according to the present embodiment, the configuration of the loss function is characteristic. The loss function according to the present embodiment includes a plurality of metric learning terms each of which is corresponding to one of the plurality of output data set. In particular, each of the plurality of metric learning terms is, for the corresponding output data set, configured to be that the value is smaller as distances in the embedding space between outputs (feature vectors) for training data with the same label among the plurality of training data are shorter. Furthermore, each of the plurality of metric learning terms is, for the corresponding output data set, configured to be that the value is smaller as distances in the embedding space between outputs for training data with the different label among the plurality of training data are longer.

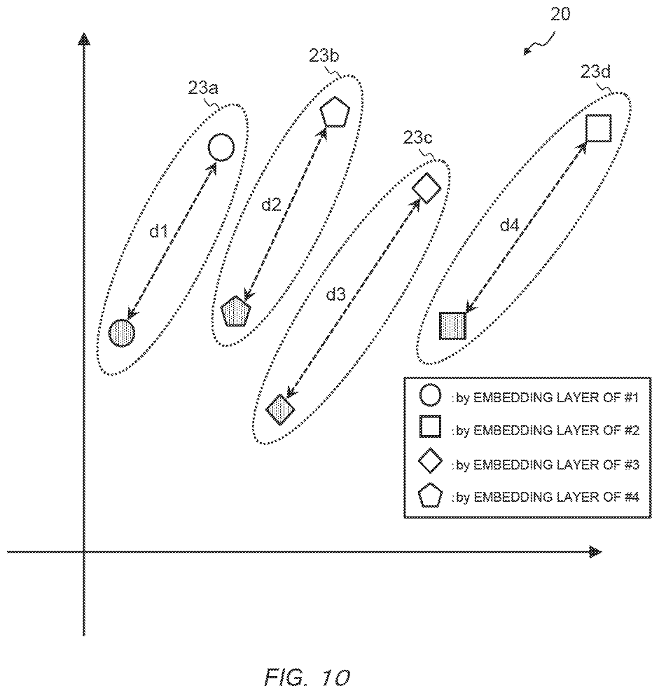

FIG. 10 is a conceptual diagram for explaining the plurality of metric learning terms. FIG. 10 is a similar drawing to FIG. 6. In particular, FIG. 10 shows when inputting two image data as training data into the machine learning model 110 shown in FIG. 4. As shown in FIG. 10, four output data sets 23a, 23b, 23c, and 23d are acquired. In FIG. 10, for each of the four output data sets, the distances d1, d2, d3, and d4 on the embedding space 20 between the outputs (feature vectors) are shown. That is, in the example shown in FIG. 10, when the labels of the two image data are the same, each of the four metric learning terms is configured such that the value is smaller as the distances d1, d2, d3, and d4 are smaller. On the other hand, when the labels of the two image data are different, each of the four metric learning terms is configured such that the value is smaller as the distances d1, d2, d3, and d4 are longer.

The loss function calculated in the learning method according to the present embodiment can be expressed by the following Formula 1. Here, Li(i=1, 2, . . . ,n) represents each of the plurality of metric learning terms, where n corresponds to the number of the plurality of output data set acquired in Step S120. Lₒₜₕₑᵣ is a term of the loss function which is given as appropriate to achieve other goal of learning. Note that Lₒₜₕₑᵣ is not a required configuration in the learning method according to the present embodiment.

Loss=L1+L2+ . . . +Ln+Lₒₜₕₑᵣ Formula 1

Li can be realized, for example, by a contrastive loss or a triplet loss. The contrastive loss and triplet loss are known, so detailed description thereof will be omitted. Alternatively, a suitable configuration may be employed as metric learning terms.

Incidentally, the distance on the embedding space 20 may employ a suitable format. Examples of the format of the distance include Euclidean distances, and cosine similarity, and the like.

See FIG. 8 again. After Step S130, the processing proceeds to Step S140.

In Step S140, the machine learning model 110 is learned such that the loss function calculated in Step S130 decreases. Typically, the parameters of the machine learning model 110 are updated by the back propagation such that the loss function decreases.

The loss function includes the plurality of metric learning terms as described above. Thus, the direction that the loss function decreases is a direction in which the distances in the embedding space 20 between outputs (feature vectors) for training data with the same label get smaller. Alternatively, the direction that the loss function decreases is a direction in which the distances in the embedding space 20 between outputs (feature vectors) for training data with the different label get longer.

After Step S140, when an exit condition is met (Step S150; Yes), learning the machine learning model 110 ends. When the exit condition is not met (Step S150; No), the processing returns back to Step S100, and the processing is repeated. Here, the exit condition is, for example, that the learning has been completed for all image data to be prepared as training data, that the loss function calculated after Step S140 becomes less than a predetermined threshold, and the like.

Incidentally, in Step S100, the acquiring training data may be performed for all image data to be prepared as training data for learning. And, in Step S110, the input of the machine learning model 110 may be a portion of training data (e.g., batch unit or epoch unit) acquired in Step S100. In this case, after Step S140, when the exit condition is not met (Step S150; No), it may be configured that the processing returns back to Step S110.

As described above, according to the learning method according to the present embodiment, the loss function is configured to include the plurality of metric learning terms. And the machine learning model 110 is learned such that the loss function decreases. It is thus possible to accomplish learning such that the machine learning model 110 outputs as shown in FIG. 7. The learning method according to the present embodiment may be applied to a computer program that causes a computer to perform processing for learning of the machine learning model 110.

Note that each of the feature vectors outputted by the plurality of embedding layers 112 is a vector on the same embedding space 20. It is thus possible that each of the plurality of metric learning terms is given by the same form of distance on the same embedding space 20. Furthermore, by constructing the loss function as shown in Formula 1, it is thus possible to equally evaluate each of the plurality of feature maps having different scales.

### 4. Re-Identification Method

Hereinafter, it will be described about the re-identification method according to the present embodiment.

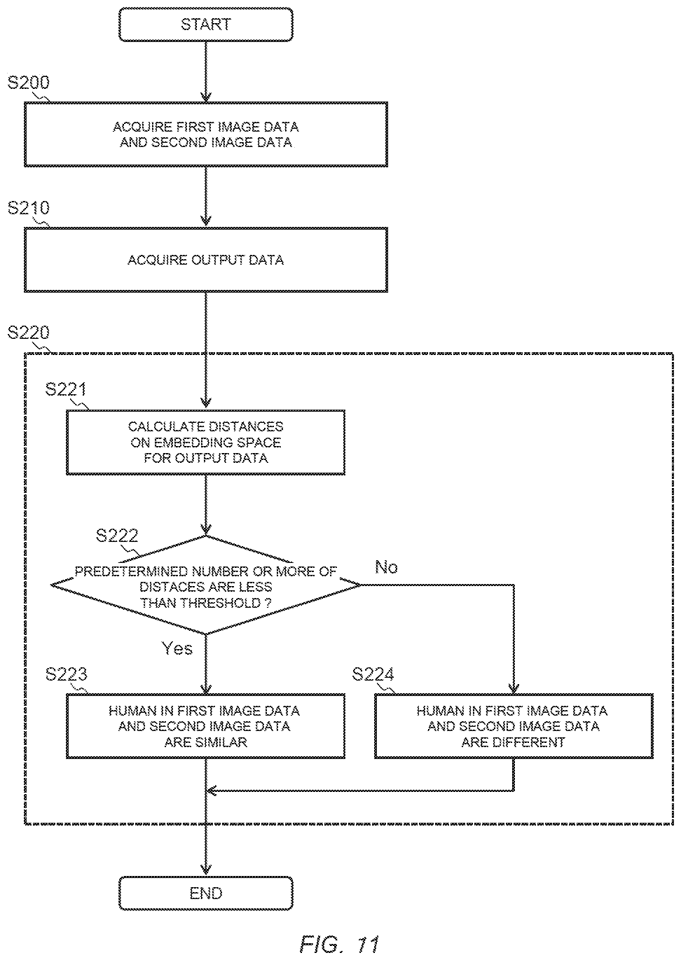

FIG. 11 is a flow chart for explaining the re-identification method according to the present embodiment. Each process of the flowchart shown in FIG. 11 is executed at every predetermined processing period. Here, in the following description, the machine learning model 110 has been learned by the learning method according to the present embodiment described above.

In Step S200, first image data and second image data are acquired as image data targeted for the human re-identification. Typically, image data of the query and image data of the gallery are acquired.

In Step S210, output data is acquired by inputting the image data acquired in Step S200 into the machine learning model 110. In particular, a plurality of first output data and a plurality of second output data are acquired. Here, the plurality of first output data is an output (feature vectors) of the plurality of embedding layers 112 by inputting the first image data. And the plurality of second output data is an output (feature vectors) of the plurality of embedding layers 112 by inputting the second image data.

After Step S210, based on the plurality of first output data and the plurality of second output data acquired in Step S210, identification between a human in the first image data and a human in the second image data is performed (Step S220). Step S220 is a process executed in the identification processing unit 132. The re-identification method according to the present embodiment has features in the processing executed in the identification processing unit 132 (from Step S221 to Step S224).

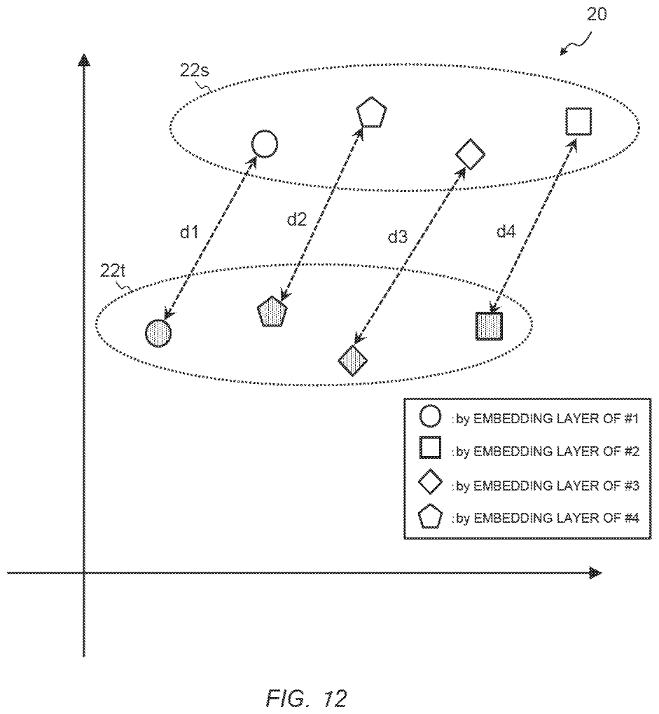

In Step S221, a plurality of distances is calculated. Here, each of the plurality of distances is a distance in the embedding space 20 between each of the plurality of first output data and each of the plurality of second output data. For example, it is assumed that the plurality of first output data 22s and the plurality of second output data 22t are acquired as output of the machine learning model 110 as shown in FIG. 12. In this case, the plurality of distances calculated in Step S221 is d1, d2, d3, and d4 shown in FIG. 12. However, the form of the distance on the embedding space 20 is equivalent to the form of the distance employed in learning of the machine learning model 110.

See FIG. 11 again. In Step S222, it is determined whether or not a predetermined number or more of the plurality of distances (calculated in Step S221) are less than a predetermined threshold. Here, the predetermined number and the predetermined threshold may be given experimentally optimally. For example, the predetermined number may be half of the number of the plurality of distances.

When the predetermined number of the plurality of distances are less than the predetermined threshold (Step S222; Yes), it is determined that the human in the first image data and the second image data are similar (Step S223). Then the processing ends. When the predetermined number of the plurality of distances are not less than the predetermined threshold (Step S222; No), it is determined that the human in the first image data and the second image data are different (Step S224).

That is, in the re-identification method according to the present embodiment, when the predetermined number or more of features represented by the plurality of feature maps having different scales are similar, it is determined that the human in the first image data and the second image data are similar. It is thus possible to judge comprehensively about various features in the human re-identification.

Incidentally, Step S210 may be performed in advance for the first image data or the second image data. For example, considering in the case the first image data is image data of the query and the second image data is image data of the gallery, the output data for the second image data may be acquired in advance. In other words, the output data acquired in Step S210 may be associated with image data of the gallery in advance.

Furthermore, when the human in the first image data and the second image data are different (Step S224), the flow chart shown in FIG. 11 may be executed repeatedly. For example, considering in the case the first image data is image data of the query and the second image data is image data of the gallery, when the human in the first image data and the second image data are different, another second image data may be acquired from image data of the gallery and the processing may be executed again.

As described above, according to re-identification method according to the present embodiment, when the predetermined number or more of the plurality of distances (calculated in Step S221) are less than the predetermined threshold, it is determined that the human in the first image data and the second image data are similar. It is thus possible to perform identification, considering each of the plurality of feature maps having different scales. Consequently, the accuracy of the human re-identification can improve.

Here, even in the re-identification method according to the present embodiment, it is noted that each of the feature vectors outputted by the plurality of embedding layers 112 is a vector on the same embedding space 20. It is thus possible to evaluate equally each of the plurality of feature maps having different scales in identification.

### 5. Re-Identification Apparatus

Hereinafter, it will be described about the re-identification apparatus according to the present embodiment.

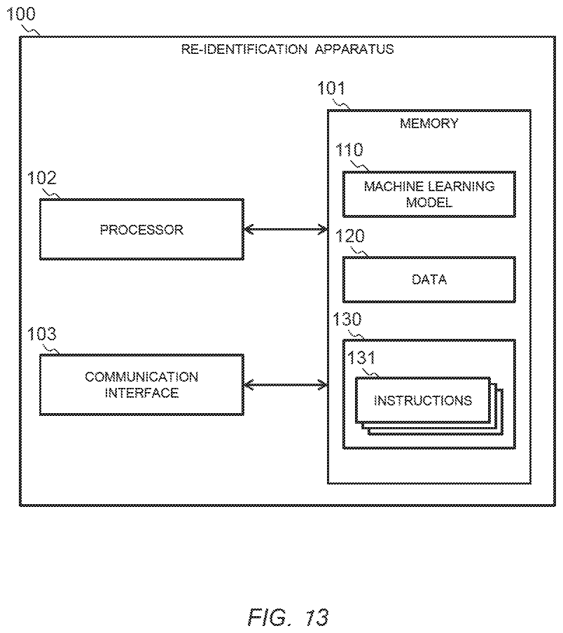

FIG. 13 is a block diagram showing a configuration of the re-identification apparatus 100 according to the present embodiment. The re-identification apparatus 100 is a computer that comprises a memory 101, a processor 102, and a communication interface 103. The memory 101 is combined to the processor 102 and stores executable instructions 131, the machine learning model 110, and various data 120 necessary for executing processes. The instructions 131 are provided by a computer program 130. The computer program 130 may be recorded on a non-transitory computer readable medium included in the memory 101. In this sense, the memory 101 may also be referred to as “program memory.”

The communication interface 103 transmits/receives information to/from external devices of the re-identification apparatus 100. For example, the re-identification apparatus 100 connects to the data base 200 through the communication interface 103. Acquiring image data, storing or updating the machine learning model 110, notifying the processing result, and the like are executed through the communication interface 103. Information acquired through the communication interface 103 is stored in the memory 101 as data 120.

The instructions 131 is configured to cause the processor 102 to execute the processes according to the re-identification method as shown in FIG. 11. That is, when the processor 102 executes the instructions 131, executing the processes according to the reidentification method as shown in FIG. 11 based on the machine learning model 110 and the data 120 are realized.

### 6. Effect

As described above, according to the present embodiment, the feature amount outputted by the machine learning model 110 is the plurality of feature vectors outputted by the plurality of embedding layers 112. And identification of a human in image data is performed by determining whether or not the predetermined number or more of the plurality of distances are less than the predetermined threshold. It is thus possible that the re-identification is performed by measuring similarity for the plurality of feature maps having different scales. Consequently, the accuracy of the re-identification can improve.

Incidentally, in the present embodiment, the case of applying to the human re-identification has been described, but it is also possible to similarly apply to the reidentification in which the target object is not a human. For example, it may similarly apply to re-identification of a dog in image data. In this case, the label may be a class of the target object, and learning by the learning method according to the present embodiment may be performed. In particular, in the present embodiment, the fineness of the class may be optional. For example, when applying to the re-identification of a dog, the class may be one that specifies individual similarly to the human re-identification, it may be one that specifies the dog species.

Furthermore, the re-identification method and the re-identification apparatus according to the present embodiment may also be implemented as part of a function or an apparatus. For example, the re-identification method may be implemented as part of the tracking function.

What is claimed is:

1. A method comprising:
acquiring a plurality of training data with a label;
inputting the plurality of training data into a machine learning model, the machine learning model comprising:
a plurality of feature extractor layers, each of which is sequentially connected and extracts a feature map of input; and
a plurality of embedding layers, each of which is connected to one of the plurality of feature extractor layers and converts the feature map to a feature vector on a embedding space with a predetermined dimension and outputs the feature vector;
acquiring a plurality of output data set, each of which is an output of one of the plurality of embedding layers;
calculating a loss function based on the plurality of output data set; and
learning the machine learning model such that the loss function decreases,
wherein the loss function includes a plurality of metric learning terms each of which is corresponding to one of the plurality of output data set, and
each of the plurality of metric learning terms is, for the corresponding output data set, configured to be:
a value is smaller as distances in the embedding space between outputs for training data with the same label among the plurality of training data are shorter; and
the value is smaller as distances in the embedding space between outputs for training data with the different label among the plurality of training data are longer.

2. The method according to claim 1, wherein
each of the plurality of training data is an image data in which a target object is, and
the label represents a class of the target object.

3. The method according to claim 2, wherein
the target object is a human, and
the class specifies an individual of the human.

4. An apparatus comprising:
one or more processors; and
a memory storing executable instructions and a machine learning model, the machine learning model comprising:
a plurality of feature extractor layers, each of which is sequentially connected and extracts a feature map of input; and
a plurality of embedding layers, each of which is connected to one of the plurality of feature extractor layers and converts the feature map to a feature vector on a embedding space with a predetermined dimension and outputs the feature vector,
wherein the instructions, when executed by the one or more processors, cause the one or more processors to execute:
acquiring first image data and second image data in both of which a target object is;
acquiring a plurality of first output data, which is outputted from the plurality of embedding layers by inputting the first image data into the machine learning model;
acquiring a plurality of second output data, which is outputted from the plurality of embedding layers by inputting the second image data into the machine learning model; and
performing re-identification between the target object in the first image data and the target object in the second image data based on the plurality of first output data and the plurality of second output data, the performing re-identification including:
calculating a plurality of distances, each of which is a distance in the embedding space between each of the plurality of first output data and each of the plurality of second output data; and
determining that the target object of the first image data and the target object of the second image data are similar when a predetermined number or more of the plurality of distances are less than a predetermined threshold.

5. The apparatus according to claim 4, wherein
the target object is a human.

6. The apparatus according to claim 4, wherein
the machine learning model has been learned by a method comprising:
acquiring a plurality of training data with a label;
inputting the plurality of training data into the machine learning model;
acquiring a plurality of output data set, each of which is an output of one of the plurality of embedding layers;
calculating a loss function based on the plurality of output data set; and
learning the machine learning model such that the loss function decreases,
wherein the loss function includes a plurality of metric learning terms each of which is corresponding to one of the plurality of output data set, and
each of the plurality of metric learning terms is, for the corresponding output data set, configured to be:
a value is smaller as distances in the embedding space between outputs for training data with the same label among the plurality of training data are shorter; and
the value is smaller as distances in the embedding space between outputs for training data with the different label among the plurality of training data are longer.

7. A method comprising:
acquiring first image data and second image data in both of which a target object is;
inputting the first image data and the second image data into a machine learning model, the machine learning model comprising:
a plurality of feature extractor layers, each of which is sequentially connected and extracts a feature map of input; and
a plurality of embedding layers, each of which is connected to one of the plurality of feature extractor layers and converts the feature map to a feature vector on a embedding space with a predetermined dimension and outputs the feature vector;
acquiring a plurality of first output data, which is an output of the plurality of embedding layers when the input is the first image data;
acquiring a plurality of second output data, which is an output of the plurality of embedding layers when the input is the second image data; and
performing re-identification between the target object in the first image data and the target object in the second image data based on the plurality of first output data and the plurality of second output data, the performing re-identification including;
calculating a plurality of distances, each of which is a distance in the embedding space between each of the plurality of first output data and each of the plurality of second output data; and
determining that the target object of the first image data and the target object of the second image data are similar when a predetermined number or more of the plurality of distances are less than a predetermined threshold.

8. The method according to claim 7, wherein
the target object is a human.

9. The method according to claim 7, wherein
the machine learning model has been learned by a method comprising:
acquiring a plurality of training data with a label;
inputting the plurality of training data into the machine learning model;
acquiring a plurality of output data set, each of which is an output of one of the plurality of embedding layers;
calculating a loss function based on the plurality of output data set; and
learning the machine learning model such that the loss function decreases,
wherein the loss function includes a plurality of metric learning terms each of which is corresponding to one of the plurality of output data set, and
each of the plurality of metric learning terms is, for the corresponding output data set, configured to be:
a value is smaller as distances in the embedding space between outputs for training data with the same label among the plurality of training data are shorter; and
the value is smaller as distances in the embedding space between outputs for training data with the different label among the plurality of training data are longer.
